(19) United States
(12) Patent Application Publication
(10) Pub. No.: US 2011/0018315 A1
(43) Pub. Date: Jan. 27, 2011

(54) BICYCLE SADDLE

(76) Inventor: Douglas DeRoy, Rolling Hills, CA (US)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(21) Appl. No.: 12/842,419

(22) Filed: Jul. 23, 2010

Related U.S. Application Data
(60) Provisional application No. 61/228,868, filed on Jul. 27, 2009.

(51) Int. Cl. B62J 1/00

(52) U.S. Cl. 297/202

(57) ABSTRACT

A bicycle saddle is described, comprising a rear platform having a surface extending substantially in a first plane and a nose having a surface that extends forward from the rear platform and is connected to the rear platform by an abrupt drop of at least 10 mm. It is an object of the invention to minimize or totally eliminate pressure on the rider's perineal artery while maintaining the necessary performance functions of the saddle nose much like the nose of a standard saddle.

### CROSS-REFERENCE TO RELATED APPLICATION

The present patent application claims the benefit (priority right) of the prior U.S. provisional patent application 61/228,868 filed on Jul. 27, 2009, the content of which is herewith incorporated in its entirety by reference.

### FIELD OF THE INVENTION

The present invention relates to bicycle saddles, and more particularly, to a bicycle saddle designed to minimize perineal pressure and increase rider comfort and safety without compromising performance.

### BACKGROUND OF THE INVENTION

Modern technological advances have revolutionized the sport of cycling. Space age materials and engineering breakthroughs have allowed for the production of bicycles of greater and greater comfort and performance. With all these advancements, however, the problems associated with bicycle saddles still have yet to be effectively addressed. A thorough discussion of the resulting physical problems, including erectile dysfunction, caused by certain bicycle saddle characteristics can be found in U.S. Pat. App. Pub. No. 2006/0119146. Many saddle manufacturers have attempted to alleviate pressure on the perineal artery, which causes the uncomfortable numbness that has been shown to lead to reproductive problems including premature impotence and testicular cancer. Most saddles designed for this purpose are made with a groove running down middle of the saddle. Although a groove running down the middle of the saddle usually makes a saddle look more ergonomic, this attribute alone will, at best, only delay the onset of numbness by a matter of minutes.

Many saddles also incorporate soft gel inserts into the rear sit pads or mid section of the saddle. While this may make the saddle initially feel more comfortable, the problem with gel padding is that as the gel compresses under a rider's weight it inevitably expands over into the rider's perineal area, putting more numbness-causing pressure on the perineal artery.

Some manufacturers even offer saddles with a range of sit pad widths to provide a more precise anatomical fit to the rider. However, these saddles still create the lack of circulation, uncomfortable numbness, and associated long-term health risks that they intend to reduce.

Another attempt to reduce the pressure on the perineal artery are “nose-less” saddles in which the entire narrow portion, or nose, of the saddle has been removed. While these saddles virtually eliminate pressure on the perineal artery, their nose-less design also significantly compromises performance. The nose of the saddle is needed for stability and balance during turns and descents as well as when riders must shift forward in the saddle to maintain traction up steep sections. For these reasons, “nose-less” designs are ill suited for entry-level riders and make mountain biking, road biking, touring, and commuting more difficult, if not more dangerous.

It is an object of the invention to minimize or totally eliminate pressure on the perineal artery, and the unhealthy numbness associated with it.

It is another object of the invention to keep the rider's weight under normal riding conditions entirely supported by the sit-pads positioned directly underneath the rider's ischial tuberosities, or sit-bones.

It is another object of the invention to remove the harmful effects of a standard saddle nose while maintaining its necessary performance functions much like the nose of a standard saddle.

### SUMMARY OF THE INVENTION

The aforementioned and other objects are achieved by a bicycle saddle comprising: a rear platform having a surface extending substantially in a first plane; and a nose having a surface that extends forward from the rear platform and is connected to the rear platform by an abrupt drop of at least 10 mm. By significantly dropping the nose of the saddle down from the top of the sit-pads the rider's weight is under normal riding conditions entirely supported by the sit-pads such that the weight is transmitted via the rider's sit bones onto the sit-pads of the rear platform. The present invention provides a saddle that will minimize or eliminate pressure on the rider's soft perineal tissue without compromising the stability and performance functions offered by the nose of a standard saddle.

### DETAILED DESCRIPTION OF THE INVENTION

According to a preferred embodiment, the rear portion of the saddle will consist of two adjacent sit-pads that are ergonomically designed to support the rider's ischial tuberosities, or sit-bones. At the transition from the rear sit-pads to the nose of the saddle, there is an abrupt and significant drop down to the nose portion of the saddle. According to this preferred embodiment, the bicycle saddle of the invention further comprises at least one central groove or a gap dividing the rear platform into a left and a right rear sit-pad and extends forward beyond the rear platform into the nose. While a significantly deep groove dividing the sit-pads might achieve the protection of the perineal area, an actual gap is preferred providing the additional advantage of flexibility of the saddle, allowing more resilience of the sit-pads, and particularly allowing the left rear sit-pad to move in relation to the right rear sit-pad and vice versa. A complete gap further has the advantage of reducing weight. According to this preferred embodiment, the gap and/or groove extends into the nose area to protect the rider's soft tissue even when sliding forward, for instance for maintaining traction of the bicycle on a steep slope.

According to another preferred embodiment the bicycle saddle according to the invention further comprises a gap dividing the rear platform into a left and a right rear sit-pad, wherein the gap is open at the rear end of the saddle and extends forward into the lower part, or beginning, of the nose. This gap then transitions forward into a central groove extending centrally along at least a part of the nose. This is a particularly preferred embodiment since it combines the advantageous properties of a complete gap with additional protection for the rider when sliding forward.

In another preferred embodiment the bicycle saddle according to the present invention the platform extends over about one-half of the entire length of the saddle and the nose over about another half of the entire length of the saddle, and the central groove or gap extends over at least half of the length of the nose into that nose. A nose having at least the same length as the sit-pads offers sufficient control.

In another preferred embodiment the bicycle saddle according to the present invention the platform extends over about one-third of the entire length of the saddle and the nose over about two-thirds of the entire length of the saddle, and the central groove or gap extends over about half the length of the nose into that nose. A longer nose in comparison to the length of the sit-pads provides enhanced control and offering the rider the option of sliding even further forward if needed. In this case, the central gap or groove should extend over at least half the length of the nose for providing the desired perineal area protection.

According to another preferred embodiment of the invention the nose extends substantially in a second plane that is parallel to the first plane and offset from the first plane by the abrupt drop. According to this embodiment of the present invention, the top surface of the nose of the saddle will follow a straight, horizontal plane forward from this low-point that is parallel to, yet 10-30 mm lower than the upper plane of the rear sit-pads. This design is particularly advantageous for protecting the rider's perineal area since the nose does not come back up towards the front after the abrupt drop and is therefore less likely to exert substantial pressure on the perineal area of the rider even in the rider's slid forward position.

According to another preferred embodiment of the invention the nose extends substantially in a second plane that extends from the low-point of the abrupt drop at an angle upwards in the direction of the first plane. In this alternative embodiment of the present invention, the top surface of the saddle may extend straight forward from this low point and then gradually rise so that the front portion of the nose is on a horizontal plane that is higher than the low-point, but 1-10 mm lower than the upper plane of the rear sit-pads. This alternative design of the present invention works particularly well if the abrupt drop is relatively high and the upward sloping angle is small so that enough space is provided between the abrupt drop and the location and where the nose reaches approximately the level of the second plane. An advantage of such a slightly upwardly inclined nose is more control and comfort in the most forward position of the rider.

According to another preferred embodiment of the invention the nose comprises a convex shape bending at a decreasing angle from the abrupt drop at an angle upwards in the direction of the first plane and reaches substantially the level of the rear platform in the front half of the nose. The convex shape of the nose might result according to another preferred embodiment of the invention in a front section of the nose that extends at an angle downwards from the position where it reaches substantially the level of the rear platform to a level that is lower than the level of the rear platform.

According to another preferred embodiment the bicycle saddle of the invention further comprises two seat rails adapted to secure the saddle to a bicycle seat post, wherein the seat rails are connected at a front end to a front section of the nose and at a rear end approximately to a center section of the respective rear sit-pads. This preferred embodiment achieves two goals: First, the seat rails support the saddle at the center the sit-pads, i.e. exactly at that position where the rider's weight is transmitted through the rider's sit bones onto the saddle. Second, in comparison to conventional saddles which typically have the seat rails attached to the very rear end of the saddle, the tendency of the saddle to bend or flex longitudinally into a concave shape under a rider's weight is significantly reduced, or completely eliminated. This helps prevent the rider's sit-bones from sliding forward under normal riding conditions. In addition, this design still allows in combination with a central gap the individual resilience of the sit-pads that can be built-in in a more controlled manner by dimensioning the seat rails and the area around the front end of the gap for implementing the desired resilience of the sit-pads without deforming the entire saddle into an undesired shape. For reducing the bending of the saddle also for the position when the rider has slid forward into the nose region, the seat rails can be connected to the saddle in a front region of the nose but spaced from the very front end by the reasonable distance leaving the very front end of the nose as a cantilever arm as far as the structural integrity of the nose allows.

According to another preferred embodiment of the invention the rear sit-pads are over most of their surface substantially flat and bordered by a downward sloping transition area. According to another preferred embodiment of the invention the rear sit-pads are over most of their surface slightly convex and bordered by a downward sloping transition area. According to another preferred embodiment of the invention the rear sit-pads are over most of their surface slightly concave and bordered by a downward sloping transition area. The downward sloping transition area helps to avoid pressure on the perineal soft tissue and other areas, including the upper hamstring, particularly when the rider is pedaling.

According to another preferred embodiment the bicycle saddle of the invention further comprises a substantially uniform ⅛ to ¼ inch padding on its rear platform and nose surfaces. As indicated, excessive padding results in the padding material being displaced into the soft tissue area of the rider. Particularly with the present design avoiding such pressure, too thick padding might defeat the purpose. However, if the gap between the sit-pads is wide enough, also a little thicker padding might be acceptable since such padding could be displaced into the gap rather than exerting pressure on the rider's perineal area.

According to another preferred embodiment of the invention the abrupt drop extends at an angle of at least 30 degrees from the surface of the rear platform down to the surface of the nose. Since the goal of the abrupt drop is to avoid pressure on the perineal area, also in the area of the abrupt drop, the dropping angle should not be too flat. The angle may vary from the exact drop area, for instance be less steep towards the lateral sides of the saddle, while steeper towards the front in direction of the nose. Preferably, the drop towards the nose is steeper than 30 degrees, for instance between 45 and 90 degrees, and can even result in an undercut, i.e. be for instance 120 degrees.

According to another preferred embodiment the bicycle saddle of the invention further comprises a bridge closing the gap at least in part. This bridge can be formed integrally, for instance when the saddle is manufactured by injection molding. It is also possible that this bridge is formed from a different material and mounted into the saddle. By choosing the appropriate thickness or size and location of the bridge that may according to one preferred embodiment only cover a small portion of the gap, also the resilience of the left sit-pad to the right sit-pad can be influenced.

According to another preferred embodiment of the invention the abrupt drop is between 10 and 30 mm. Even bigger drops of for instance 40 or even 50 mm work well, particularly in designs where the nose is inclined upward toward its front upwards. In either of these embodiments of the present invention, the saddle will feature an abrupt drop of at least 10 mm along a 30-90 degree slope from the front edge of the sit-pads down to the narrower nose portion of the saddle. This means that the rider's perineal soft tissue will be positioned above the dropped down portion of saddle nose so that the only points of the rider's anatomy in weight-bearing contact with the saddle are the sit-bones on the ergonomic sit-pads.

In addition to the elements described above, the preferred embodiments of the present invention will include the following features that will enhance the performance, comfort, and health benefits of the saddle. First, in order to preserve the stability and performance attributes of a standard saddle nose, the saddle will have a nose section that is at least as long as the longitudinal length of the sit-pads. Second, to decrease saddle weight, help the sit-pads flex more independently, and relieve pressure on perineal soft tissue during times when the rider must shift forward onto the nose of the saddle, the saddle will feature either a groove, or a complete gap, between the two rear sit-pads that transitions into a groove extending up some length of the saddle nose. Third, in order to help keep the rider's sit-bones properly positioned on the sit-pads during normal riding, the upper surface of the rear sit-pads will be ergonomically shaped and padded. Fourth, to increase structural strength and ensure that any downward flexing of the saddle does not force the rider's sit-bones to shift laterally or longitudinally from the center of the sit-pads, the rear rail mounts will be positioned directly below the point where the rider's sit-bones will be. Finally, the saddle will consist of a hard, flexible, injection-molded plastic shell mounted to metal rails, and topped with a layer of closed-cell foam or other padding material, and a thin leather, or rubberized fabric, cover that is stretched over the topside and secured to the inside of the rim that forms the perimeter of the saddle shell. The present invention will in the following be further explained by referring to the drawings.

### BRIEF DESCRIPTION OF THE DRAWINGS

FIG. 1 illustrates a side view of the saddle in accordance with one preferred embodiment of the present invention.

FIG. 2 illustrates a side view of the saddle in accordance with an alternative preferred embodiment of the present invention.

FIG. 3 illustrates a top view of the saddles shown in FIG. 1 and FIG. 2.

FIG. 4 illustrates a rear view of the saddle shown in FIG. 1.

FIG. 5 illustrates a perspective view of the saddle shown in FIG. 1.

### DETAILED DESCRIPTION OF THE DRAWINGS

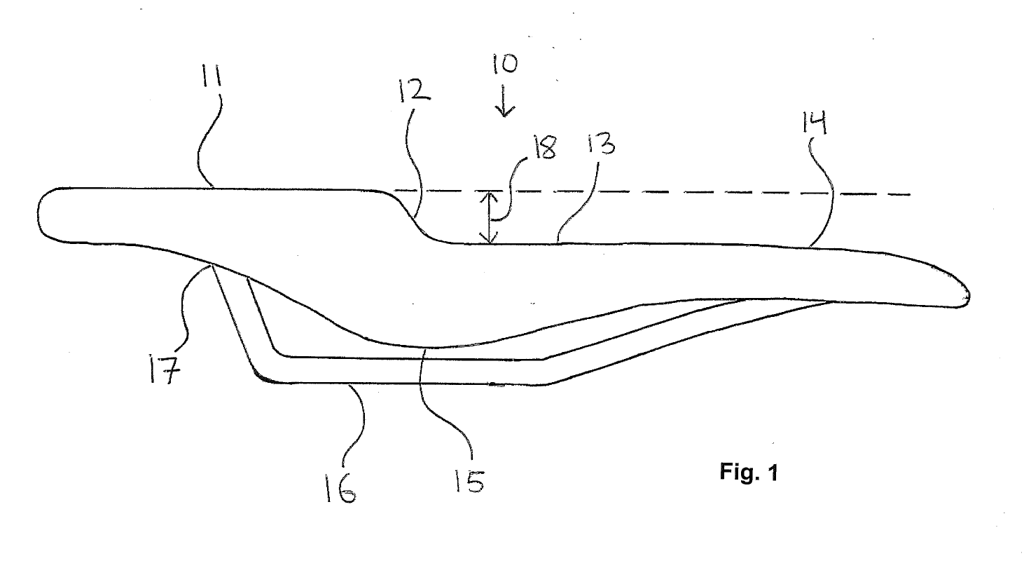

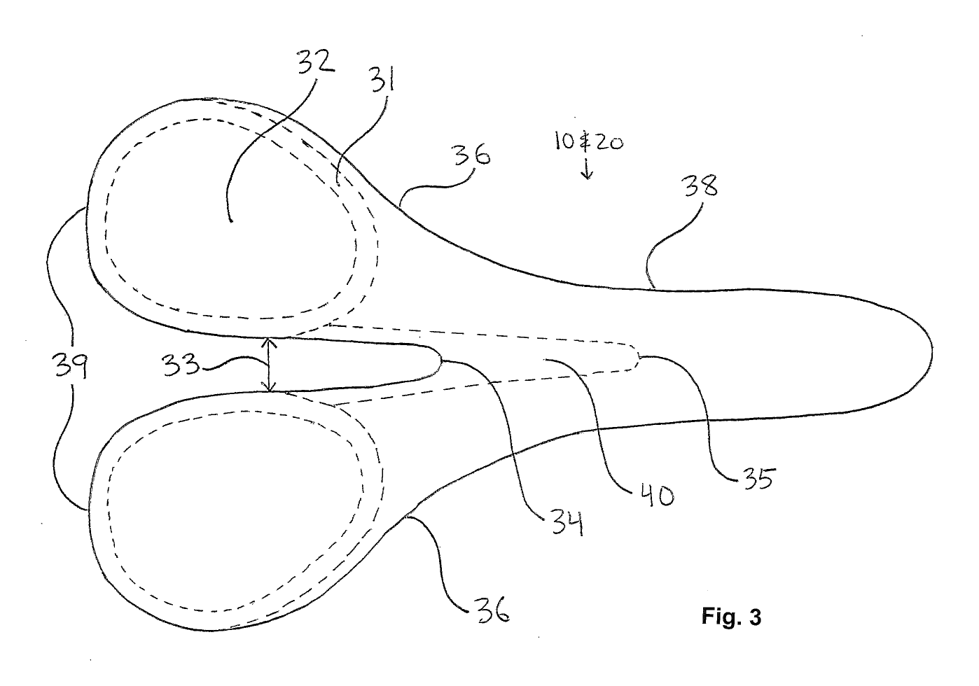

In the figures described below, like numerals reflect identical parts. FIG. 1 illustrates a side view of saddle 10, which represents one preferred embodiment of the present invention. Saddle 10 has a level rear platform 11 extending over approximately the rear third of the longitudinal length of the saddle 10. Moving forward from the leading edge of the rear platform 11, there is an abrupt, yet smoothly transitioned, 10-30 mm drop 12 down to the level middle section 13 of the saddle, which then extends along a level plane to the nose 14 of saddle 10. The slope of the drop 12 is 30-90 degrees, and the 10-30 mm drop distance 18 is the difference in elevation between the horizontal planes of the rear platform 11 and the middle section 13. The nose 14 of the saddle 10 is at least as long as the longitudinal length of the rear platform 11. To provide increased rider stability, comfort, and control here are curved lobes 15 on each side of the saddle 10, positioned approximately from the outer, front half of the rear platform 11 to the point below the drop 12 and the transition to the middle section 13. The lowest point of the curved lobes 15 may be above or below the seat rails 16. The seat rails 16 allow the saddle 10 to be secured to any standard bicycle seat post, and the rear attachment point 17 for the seat rails 16 is positioned at the midpoint of the longitudinal length of the rear platform 11. This central attachment point, combined with the ergonomically shaped sit-pads described in FIG. 3, helps to keep the rider's sit-bones from shifting forward or backward on the rear platform 11 or sit-pads 39. The seat rails 16 are made from metal and the remaining saddle is substantially made by injection molding. The seat rails are attached to respective attachment points that can be molded as an integral part of the saddle and/or secured through the use of pressure, epoxy, hardware, or any combination thereof.

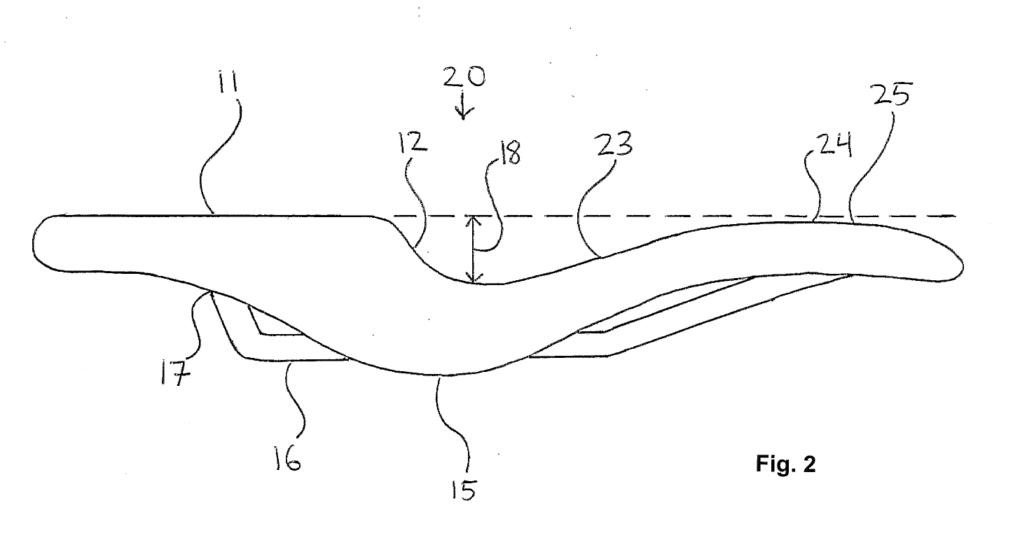

FIG. 2 illustrates a side view of saddle 20, which represents an alternative preferred embodiment of the present invention. See the above description of FIG. 1 for description involving parts numbered 11, 12, 15, 16, 17, and 18. A difference between saddle 20 and saddle 10 is that saddle 20 has an upward sloping middle section 23 that transitions forward to the level nose 24. Thus, the nose 24 of saddle 20 will occupy a horizontal plane that is 1-10 mm below that of the level rear platform 11. This 1-10 mm distance is measured at approximately the point labeled 25. The combined length of the upward sloping middle section 23 and the nose 24 is at least as long as the longitudinal length of the rear platform 11. As this embodiment demonstrates also, the abrupt drop 12 can be bigger than in the embodiment shown in FIG. 1, on the one hand for allowing the nose to be inclined upwards, on the other hand for providing enough space between the middle part of the nose and the sit-pads to protect the perineal area of the rider.

FIG. 3 illustrates a top view of saddle 10 and saddle 20. The rear platform is comprised of two rear sit-pads 39 which are separated, in parallel, by a complete gap 33 which extends forward to a convergence point 34 approximately where width of the sit-pads 39 abruptly taper in 36 and transition to the narrower nose 38. In lieu of the complete gap, a groove can be provided. However, a groove 40 extends along the centerline of the nose 38 to a point 35 approximately half to two-thirds up the length of the nose 38. The main contact area 32 on the top surface of each of the rear sit-pads 39 is bordered by a downward sloping transition area 31 to create an ergonomically rounded, comfortable shape. This rounded, ergonomic shape helps to keep the rider's sit-bones properly positioned on the rear sit-pads 39 and removes any painful pressure points from the rider's pedal stroke.

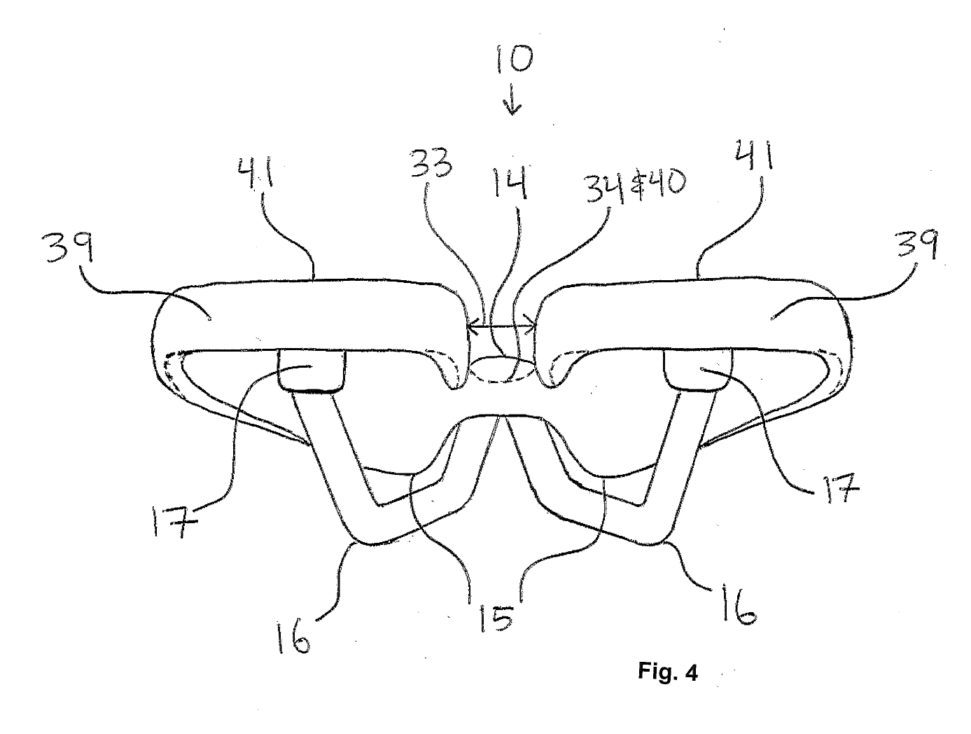

FIG. 4 illustrates a rear view of saddle 10. See the above description of FIG. 1 for description involving parts numbered 14 and 15, and FIG. 3 for description involving parts numbered 33, 34, and 40. The rear attachment points 17 for the seat rails 16 are mounted directly below the center contact points 41 of each of the rear sit-pads 39. This central attachment point, combined with the ergonomic shape of the sit-pads described in FIG. 3, helps to keep the rider's sit-bones from shifting from the center of the rear sit-pads 39.

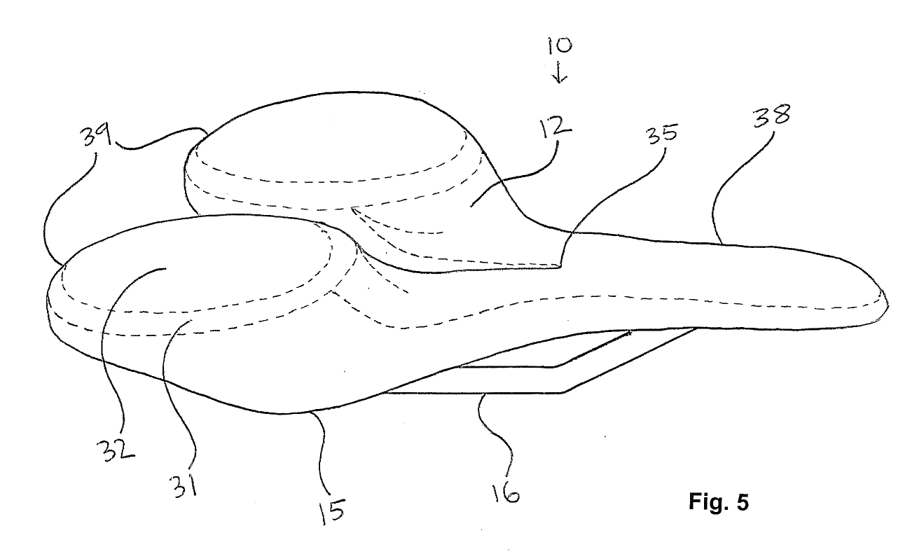

FIG. 5 illustrates a perspective view of saddle 10. In this figure, dashed lines have been added to help depict the three-dimensional contours of the saddle 10. This figure provides an angled and tilted perspective of the saddle 10 to help show the combination of FIG. 1 and FIG. 3 together. Descriptions of all of the numbered features in this figure can be found in the above descriptions of FIG. 1 and FIG. 3.

What is claimed is:

1. A bicycle saddle comprising:
a rear platform having a surface extending substantially in a first plane; and
a nose having a surface that extends forward from the rear platform and is connected to the rear platform by an abrupt drop of at least 10 mm.

2. The bicycle saddle of claim 1, further comprising at least one central groove or a gap dividing the rear platform into a left and a right rear sit-pad and extending forward beyond the rear platform into the nose.

3. The bicycle saddle of claim 1, further comprising a gap dividing the rear platform into a left and a right rear sit-pad, wherein the gap is open at a rear end of the saddle and extends forward into the lower section of the nose and transitions into a central groove extending centrally along at least a part of the nose.

4. The bicycle saddle of claim 2, wherein the platform extends over about one-half of the entire length of the saddle and the nose over about another half of the entire length of the saddle, and the central groove or gap extends over at least half of the length of the nose into that nose.

5. The bicycle saddle of claim 2, wherein the platform extends over about one-third of the entire length of the saddle and the nose over about two-thirds of the entire length of the saddle, and the central groove or gap extends over about half the length of the nose into that nose.

6. The bicycle saddle of claim 1, wherein the nose extends substantially in a second plane that is parallel to the first plane and offset from the first plane by the abrupt drop.

7. The bicycle saddle of claim 1, wherein the nose extends substantially in a second plane that extends from the low-point of the abrupt drop at an angle upwards in the direction of the first plane.

8. The bicycle saddle of claim 7, wherein the nose comprises a convex shape bending at a decreasing angle from the abrupt drop at an angle upwards in the direction of the first plane and reaches substantially the level of the rear platform in the front half of the nose.

9. The bicycle saddle of claim 7, wherein a front section of the nose extends at an angle downwards from the position where it reaches substantially the level of the rear platform to a level that is lower than the level of the rear platform.

10. The bicycle saddle of claim 2, further comprising two seat rails adapted to secure the saddle to a bicycle seat post, wherein the seat rails are connected at a front end to a front section of the nose and at a rear end approximately to a center section of the respective rear sit-pads.

11. The bicycle saddle of claim 2, wherein the rear sit-pads are over most of their surface substantially flat and bordered by a downwards sloping transition area.

12. The bicycle saddle of claim 2, wherein the rear sit-pads are over most of their surface slightly convex and bordered by a downwards sloping transition area.

13. The bicycle saddle of claim 2, wherein the rear sit-pads are over most of their surface slightly concave and bordered by a downwards sloping transition area.

14. The bicycle saddle of claim 1, further comprising a substantially uniform ⅛ to ¼ Inch padding on its rear platform and nose surfaces.

15. The bicycle saddle of claim 1, wherein the abrupt drop extends at an angle of at least 30 degrees from the surface of the rear platform down to the surface of the nose.

16. The bicycle saddle of claim 2, further comprising a bridge closing the gap at least in part.

17. The bicycle saddle of claim 1, wherein the abrupt drop is between 10 and 30 mm.
